(19) United States
(12) Patent Application Publication
(10) Pub. No.: US 2026/0087263 A1
(43) Pub. Date: Mar. 26, 2026

(54) SYSTEMS AND METHODS FOR HUMAN-TO-AI CONVERSATIONAL EVIDENCE

(71) Applicant: RELATIVITY ODA LLC, Chicago, IL (US)

(72) Inventors: Chris Brown, Chicago, IL (US); Lindsey Lanier, Chicago, IL (US); Alexander Martin, Chicago, IL (US); Greg Evans, Chicago, IL (US); Andrea Beckman, Chicago, IL (US); James A. Witte, JR., Chicago, IL (US); Peter Lembke, Chicago, IL (US)

(21) Appl. No.: 19/337,356

(22) Filed: Sep. 23, 2025

Related U.S. Application Data
(60) Provisional application No. 63/698,531, filed on Sep. 24, 2024.

(51) Int. Cl. G06F 40/35; G06F 16/383

(52) U.S. Cl. CPC G06F 40/35; G06F 16/383

(57) ABSTRACT

The following relates generally to: (i) converting conversation logs to composite message files; (ii) ingesting the composite message files into a review workspace; and/or (iii) classify component messages of a composite message file using generative AI. In some embodiments, one or more processors: obtain a conversation log indicative of a series of user interactions with a generative AI platform; process the conversation log to convert the conversation log into a composite message file, the composite message file including component messages representative of the series of user interactions; associate the composite message file with conversation metadata derived from the conversation log, wherein the conversation metadata includes one or more of conversation entities or contextual embeddings generated by the generative AI platform; associate the component messages with respective message metadata derived from the component message file; ingest the composite message file into the review workspace.

### CROSS REFERENCE TO RELATED APPLICATIONS

This application claims priority to and the benefit of the filing date of U.S. Provisional Application No. 63/698,531, entitled “Systems and Methods for Human-to-AI Conversational Evidence” (filed September 24, 2024), the entire contents of which is hereby expressly incorporated herein by reference.

### FIELD

The present disclosure generally relates to ingesting conversation logs, such as human to artificial intelligence conversation logs, emails, SMS (short message service) communications, group texts, etc., into a review workspace, and more particularly relates to ingesting component messages of a conversation log by, among other things: (i) converting the conversation logs into composite message files including component messages; (ii) associating the composite message file with conversation metadata; (iii) associating the component messages with respective message metadata; and/or (iv) ingesting the composite message file into the review workspace.

### BACKGROUND

In the eDiscovery process commonly associated with litigation, for example, reviewers (e.g., attorneys) are commonly provided with a voluminous corpus of documents (e.g., emails, SMS communications, group texts, presentations, reports, spreadsheets, etc.) that conform to a discovery request.

Human to artificial intelligence (AI) evidence has recently emerged as a new evidence type in the eDiscovery process. The ways in which these conversational AI tools are being used are different than traditional digital communication means; these interactions which include context around an individual's thought processes, intentions, and decision making can create a compelling timeline of a person's evolving thoughts and actions for cases. However, entire conversation logs from human to AI interactions may include a significant amount of irrelevant information, and accordingly, simply adding such conversation logs to an already voluminous corpus of documents may obscure the context around an individual's thought process, intentions, and decision making.

Rather than manually review each document in the corpus, eDiscovery processes sometimes deploy machine learning models to identify documents responsive to an inquiry (e.g., identifying privileged documents, documents responsive to a discovery request, etc.). However, in some instances, even deploying machine learning models may be cumbersome and inefficient. For example, training a machine learning classifier may require manual review of thousands of documents to generate a sufficient number of labeled training examples for the classifier to satisfy performance requirements. Moreover, if the relevant portion of the large documents is just a small portion of the overall document, the machine learning classifier may be updated based on the wrong document information.

The systems and methods disclosed herein provide solutions to these problems and may provide solutions to the ineffectiveness, insecurities, difficulties, inefficiencies, encumbrances, and/or other drawbacks of conventional techniques.

### SUMMARY

In one aspect, a computer-implemented method for ingesting conversation logs from generative artificial intelligence (AI) platforms into a review workspace may be provided. In one example, the method may include: (1) obtaining, by one or more processors, a conversation log indicative of a series of user interactions with a generative artificial intelligence (AI) platform, the user interactions including input prompts and respective responses provided by the generative AI platform; (2) processing, by the one or more processors, the conversation log to convert the conversation log into a composite message file, the composite message file including component messages representative of the input prompts and the respective responses; (3) associating, by the one or more processors, the composite message file with conversation metadata derived from the conversation log, wherein the conversation metadata includes one or more of: conversation entities, or contextual embeddings generated by the generative AI platform; (4) associating, by the one or more processors, the component messages with respective message metadata derived from the component message file; (5) ingesting, by the one or more processors, the composite message file into the review workspace. The method may include additional, fewer, or alternate actions, including those discussed elsewhere herein.

In yet another aspect, a computer system for ingesting conversation logs from generative artificial intelligence (AI) platforms into a review workspace may be provided. In one example, the computer system may include: one or more processors; and/or one or more non-transitory memories coupled to the one or more processors. The one or more non-transitory memories including computer executable instructions stored therein that, when executed by the one or more processors, may cause the one or more processors to: (1) obtain a conversation log indicative of a series of user interactions with a generative AI platform, the user interactions including input prompts and respective responses provided by the generative AI platform; (2) process the conversation log to convert the conversation log into a composite message file, the composite message file including component messages representative of the input prompts and the respective response; (3) associate the composite message file with conversation metadata derived from the conversation log, wherein the conversation metadata includes one or more of: conversation entities, or contextual embeddings generated by the generative AI platform; (4) associate the component messages with respective message metadata derived from the component message file; (5) ingest the composite message file into the review workspace. The computer system may include additional, less, or alternate functionality, including that discussed elsewhere herein.

In yet another aspect, a tangible, non-transitory computer readable medium storing computer-readable instructions for ingesting conversation logs from generative artificial intelligence (AI) platforms into a review workspace may be provided. In one example, the tangible, non-transitory computer readable medium, when executed by one or more processors of a computer system, may cause the computer system to: (1) obtain a conversation log indicative of a series of user interactions with a generative AI platform, the user interactions including input prompts and respective responses provided by the generative AI platform; (2) process the conversation log to convert the conversation log into a composite message file, the composite message file including component messages representative of the input prompts and the respective response; (3) associate the composite message file with conversation metadata derived from the conversation log, wherein the conversation metadata includes one or more of: conversation entities, or contextual embeddings generated by the generative AI platform; (4) associate the component messages with respective message metadata derived from the component message file; (5) ingest the composite message file into the review workspace.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems, and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer environment for ingesting conversation logs into a review workspace which the exemplary computer-implemented methods described herein may be implemented.

FIG. 2A illustrates an example conversation log from a generative artificial intelligence (AI) platform.

FIG. 2B illustrates an example contextual embedding generated by a generative artificial intelligence (AI) platform during a conversation.

FIG. 3 illustrates an example screen allowing a user to review a composite message file generated based on a conversation log from a generative artificial intelligence (AI) platform.

FIG. 4 illustrates an example screen allowing a user to provide review data for component messages of a composite message file.

FIG. 5 illustrates an example screen allowing a user to review a composite message file and associated metadata.

FIG. 6 illustrates an example screen allowing a user to specify formatting for a production document corresponding to a conversation log.

FIG. 7 illustrates an example screen allowing a user to review a production document corresponding to a conversation log.

FIG. 8 illustrates an example computer-implemented method for ingesting conversation logs into a review workspace.

FIG. 9 illustrates an example computing system, according to an embodiment.

### DETAILED DESCRIPTION

The present techniques relate to ingesting conversation logs (e.g., human to AI conversation logs, emails, SMS communications, group texts, etc.) into a review workspace, and more particularly relate to facilitating review of conversation logs by: (i) converting the conversation logs into composite message files including component messages; (ii) associating the composite message file with conversation metadata; (iii) associating the component messages with respective message metadata; and/or (iv) ingesting the composite message file into the review workspace.

In some embodiments, these techniques are applied in the eDiscovery process. For example, in the eDiscovery process, reviewers (e.g., attorneys, etc.) are commonly provided with a voluminous corpus of documents (e.g., emails, SMS communications, group texts, presentations, reports, spreadsheets, etc.) that conform to a discovery request. Thus, rather than manually review each document in the corpus, eDiscovery processes commonly deploy machine learning models to identify documents responsive to an inquiry (e.g., identifying privileged documents, documents responsive to a discovery request, etc.). However, these machine learning processes involve a significant number of manually-labeled training examples before a classifier can be sufficiently trained to have statistical confidence in its performance with respect to remaining documents in the corpus. Thus, some conventional machine learning-based processes involve a significant amount of manual review time (including identification of the relevant portions for training) before the machine learning classifiers can be deployed.

As mentioned above, human to AI interactions (e.g., human interactions with an AI chatbot or other type of generative AI model) have recently emerged as a new evidence type in the eDiscovery process, and may provide particular insight into an individual's thought process, intentions, and decision making. In some scenarios, a corpus of documents provided to reviewers may include human to AI conversation logs. However, conventional machine learning-based processes would still involve a significant amount of manual review time to extract the particular insight into an individual's thought process, intentions, and decision making reflected in such a conversation log.

The techniques described herein relate to processing conversation level metadata and processing message level metadata. Said another way, techniques described herein relate to converting conversation logs (e.g., human to AI conversation logs, emails, SMS communications, group texts) into composite message files that include component messages corresponding to component communications of a conversation log (e.g., individual messages in a conversation log). As one example, a human to AI conversation log may include component communication from a user and component messages from a generative AI platform (e.g., messages generated by a generative AI platform in response to a user provided prompt), and component messages of the corresponding composite message file may be representative of the input prompts from a user and the respective responses from the generative AI platform. Other examples will be described in more detail below. By converting such conversation logs to composite message files, conversation level metadata (e.g., entities, conversation topics, dates and times, contextual embeddings, etc.) may be associated with a corresponding composite message file, while message level metadata (e.g., contextual embeddings, recipient and sender identifications, dates and times, etc.) may be associated with a corresponding component message. This may improve the ability to extract information from a conversation log (e.g., for training a machine learning classifier or providing other meta-analyses of the corpus of documents).

Generally, the techniques described herein also may be applied to classifying component messages of a composite message file. In this way, granular insight into an individual's thought process, intentions, and decision making may be provided through the classification of component messages and association of message level metadata with the component messages. For example, contextual embeddings may be generated by a generative AI platform in response to user input, and may be associated with a component message and/or a composite message file as message level metadata and/or conversation level metadata respectively. Continuing with this example, a contextual embedding may be indicative of: message and response context, user intent, user preferences, user sentiment, conversation topics, etc., and accordingly may provide unique insight into an individual's though process, intentions, and decision making through association with component messages and/or composite message files. It should be appreciated that while the techniques described here in place emphasis on human to AI interactions, various other conversation log types may be similarly converted into composite message files and processed as described herein.

As will be explained herein, there are unique challenges to overcome to efficiently convert conversation logs into composite message files for facilitating classification of component messages. For example, some conversation logs are not in a format that segments out the component messages. Accordingly, in these examples, a parser may need to be trained to detect and segment the various component messages.

The systems and methods disclosed herein provide solutions to these problems and others.

### Example Environment

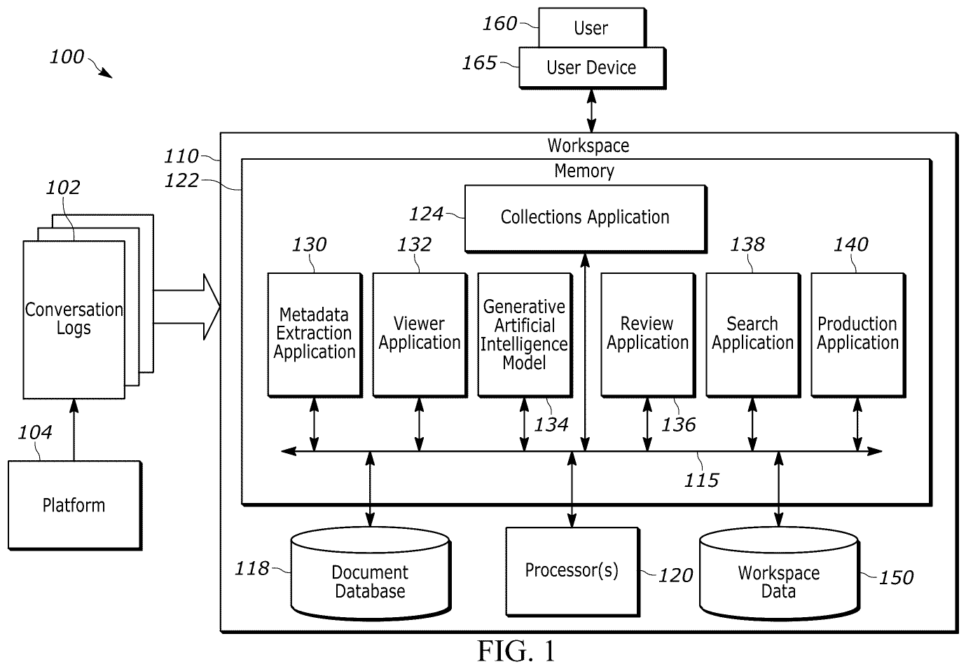

To this end, FIG. 1 illustrates an exemplary computer environment 100 for ingesting conversation logs into a review workspace by: (i) converting the conversation logs into composite message files including component messages, and/or (ii) ingesting the composite message file into the review workspace in which the exemplary computer-implemented methods described herein may be implemented. The high-level architecture includes both hardware and software applications (e.g., the one or more processors 120 and the memory 122), as well as various data communications channels (e.g., the bus 115) for communicating data between the various hardware and software components.

As illustrated, the computing environment 100 includes a workspace 110 (e.g., the review workspace) associated with conversation logs 102, such as a set of conversation logs associated with an eDiscovery project. The conversation logs 102 may have conversation types. Examples of the conversation type include: a human to AI interaction log, an email conversation log, an SMS conversation log, a group text conversation log, etc.

The workspace 110 and/or the components thereof may be implemented as software modules within a cloud and/or distributed computing system (e.g., Amazon Web Services (AWS) or Microsoft Azure). Accordingly, the components of the workspace 110 may include separate logical addresses via which the components are accessible via a bus 115 or other messaging channel supported by the cloud computing system. In some embodiments, the workspace 110 includes multiple instances of the same component to increase the ability of parallelization for the various functions performed via the respective components.

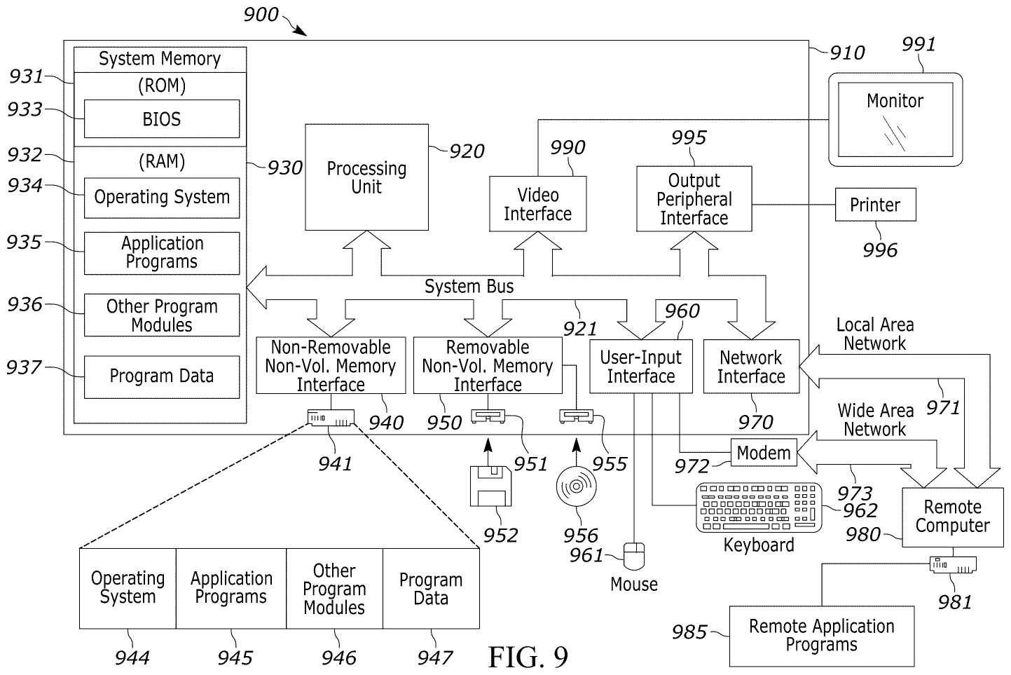

To implement the computing environment 100, a computing system may be used, such as computing system 900 of the example of FIG. 9 to host and/or execute at least a portion of the workspace 110. The computing system 900 may include a computer 910. Components of the computer 910 may include, but are not limited to, a processing unit 920 (such as a processing unit that includes the one or more processors 120), a system memory 930 (such as a memory unit that implements the memory 122), and a system bus 921 that couples various system components including the system memory 930 to the processing unit 920. In some embodiments, the processing unit 920 may include one or more parallel processing units capable of processing data in parallel with one another. The system bus 921 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 910 may include a variety of computer-readable media. Computer-readable media may be any available media that can be accessed by computer 910 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 930 may include computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to, and/or presently being operated on, by processing unit 920. By way of example, and not limitation, FIG. 9 illustrates operating system 934, application programs 935, other program modules 936, and program data 937. For example, the application programs 935, the program modules 936 and/or the program data 937 may include any of the applications executed within the workspace 110.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 may be connected to the system bus 921 through a non-removable memory interface such as interface 940, and magnetic disk drive 951 and optical disk drive 955 may be connected to the system bus 921 by a removable memory interface, such as interface 950.

The drives and their associated computer storage media discussed above and illustrated in FIG. 9 provide storage of computer-readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as cursor control device 961 (e.g., a mouse, trackball, touch pad, etc.) and keyboard 962. A monitor 991 or other type of display device is also connected to the system bus 921 via an interface, such as a video interface 990. In addition to the monitor, computers may also include other peripheral output devices such as printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and may include many or all of the elements described above relative to the computer 910, although only a remote memory storage device 981 has been illustrated in FIG. 9. The logical connections depicted in FIG. 9 include a local area network (LAN) 971 and a wide area network (WAN) 973, but may also include other networks. Such networking environments are commonplace in hospitals, offices, enterprise-wide computer networks, intranets and the Internet.

When used in a LAN networking environment, the computer 910 is connected to the LAN 971 through a network interface or adapter 970. When used in a WAN networking environment, the computer 910 may include a modem 972 or other means for establishing communications over the WAN 973, such as the Internet. The modem 972, which may be internal or external, may be connected to the system bus 921 via the input interface 960, or other appropriate mechanism. The communications connections 970, 972, which allow the device to communicate with other devices, are an example of communication media, as discussed above. In a networked environment, program modules depicted relative to the computer 910, or portions thereof, may be stored in the remote memory storage device 981. By way of example, and not limitation, FIG. 9 illustrates remote application programs 985 as residing on the remote memory storage device 981.

The techniques for ingesting conversation logs into a review workspace described herein may be implemented in part or in their entirety within a computing system such as the computing system 900 illustrated in FIG. 9. In some embodiments, the computing system 900 is a server computing system communicatively coupled to a local workstation (e.g., a remote computer 980) via which a user interfaces with the computing system 900. For example, the computer 910 may be configured to present one or more user interfaces at a local workstation (e.g., a client device; the user device 165) for presentation thereat to present outputs of a prompt-based classification model used in conjunction with the generative AI model 134 to classify documents in the conversation logs 105 (e.g., to classify component message files of a conversation log and/or to classify composite message files).

In some embodiments, the computing system 900 may include any number of computers 910 configured in a cloud or distributed computing arrangement. Accordingly, the computing system 900 may include a cloud computing manager system (not depicted) that efficiently distributes the performance of the functions described herein between the computers 910 based on, for example, a resource availability of the respective processing units 920 or system memories 930 of the computers 910. In these embodiments, the conversation logs 102 and/or the data associated with the prompt-based classification model used in conjunction with the generative AI model 134 may be stored in a cloud or distributed storage system (not depicted) accessible via the interfaces 971 or 973. Accordingly, the computer 910 may communicate with the cloud storage system to access the documents within the corpus of documents, for example, when generating an embedding vector as part of the model training process.

As illustrated, the workspace 110 includes various modules and/or applications (e.g., stored on the memory 122) that can be executed, via the one or more processors 120, within the workspace 110. For example, workspace 110 may include the collections application 124, the metadata extraction application 130, the viewer application 132, the generative AI model 134, the review application 136, the search application 138, and/or the production application 140. In some embodiments, the viewer application 132 is used to present composite message files invoked by the review application 136 to present documents for review data.

In operation, the applications executing within the workspace 110 may be configured to facilitate ingestion of conversation logs 102 into the workspace 110 for review. The collections application 124 may be configured to present a user interface by which a user may provide information associated with the platform 104 from which the conversation logs 102 are to be imported (e.g., account data for the platform, such as login credentials, a date range for the conversation logs of interest, etc.). For example, the platform 104 may be a generative AI platform (e.g., OpenAI, Google Gemini, etc.), an email platform (e.g., outlook, Gmail, etc.), a group messaging platform (e.g., Microsoft Teams), etc. In some embodiments, the collections application 124 may obtain the conversation logs 102 from various generative AI platforms based on the provided user input associated with a generative AI platform. For example, a user may provide information associated with an account for the platform 104 and information associated with one or more conversation logs of interest via a user interface presented by the collections application 124. In response, the collections application 124 may then obtain the one or more conversation logs of interest (e.g., conversation logs 102) via an application programming interface (API) of the platform 104.

As mentioned above, the applications executing within the workspace 110 may be configured to facilitate ingestion of conversation logs 102 into the workspace 110 for review. When ingested, the conversation logs 102 may be stored at one or more locations, including a local document cache or local document database 118 and/or a remote storage system (not depicted), such as a data lake or other cloud-storage system. In some embodiments, the conversation logs 102 may be included in a larger corpus of documents associated with a request for production, in the eDiscovery context. Additionally or alternatively, the metadata extraction application 130 may be configured to process the conversation logs 102 to convert the conversation logs 102 into respective composite message files each including two or more component messages. In some embodiments, the metadata extraction application 130 may be configured to associate a composite message file with respective conversation metadata derived from a corresponding conversation log. Additionally or alternatively, the metadata extraction application 130 may be configured to associate the component messages with respective message metadata derived from the corresponding composite message file.

In some embodiments, the conversation metadata may include conversation entities, contextual embeddings (e.g., memory embeddings generated by an generative AI platform during a conversation for a user prompt input to the generative AI platform and/or a corresponding response; contextual embeddings indicative of context, user intent, user preferences, user sentiment, conversation topics, etc.), and/or coding decisions from a user (e.g., a relevance of a component message, responsiveness of a component message, a privilege level for a component message, etc.). Additionally or alternatively, the metadata extraction application 130 may be configured to segment the conversation logs 102 into component communication corresponding to an individual message from an entity of the conversation (e.g., a prompt input to a generative AI platform by a user, or a corresponding response from the generative AI platform; a question sent over text from a first entity, or a response to the question from a second entity; etc.) and the metadata extraction application 130 may be configured to generate the composite message based on the segmented component communications. The message metadata may include metadata extracted from metadata associated with the segmented component communications (e.g., timestamps, location data, user input type, etc.). In some embodiments, the message metadata may include coding decisions, contextual embeddings generated by the associated generative AI platform, classifications of the corresponding component message generated by the generative AI model 134 (e.g., a responsiveness classification, a relevancy classification, a privilege classification, etc.), review data (e.g., from the user 160), and/or redaction metadata (e.g., a redaction term set, personal identifiable information, intellectual property, health information, government data, financial information, etc.) associated with a respective component message. In some embodiments, the conversation metadata may include the message metadata.

In some embodiments, the viewer application 132 may be configured to present a user interface by which a user may review composite message files and corresponding metadata (e.g., conversation metadata and/or message metadata). Additionally or alternatively, the review application 136 may be configured to present a user interface by which a user may input coding decisions and/or review data for a composite message file, such as whether component messages are responsive to a relevancy requirement, are responsive to an inquiry, and/or are privileged.

The applications executing within the workspace 110 may be further configured to facilitate the classification of documents in the conversation logs 102. Additionally or alternatively, the review application 136 may be configured to present a user interface by invoking the viewer application 132 to facilitate manual review of documents. Additionally, the review application 136 may present user interfaces via which a user may define prompt criteria (e.g., a description of one or more issues and/or one or more relevancy requirements) that are used to define a classification performed by the prompt-based classification model used in conjunction with the generative AI model 134 to classify component messages of a composite message file (e.g., a composite message file corresponding to a conversation log of the conversation logs 102). Additionally or alternatively, the prompt criteria may define relevancy criteria and issues associated with an inquiry related to the conversation logs 102 and/or relevancy criteria and issues associated with the classification performed by the prompt-based classification model used in conjunction with the generative AI model 134 to classify a composite message file or component messages of a composite message file. For example, if the conversation logs 102 are associated with a lawsuit, relevancy criteria may describe how to assess whether a document is relevant to a production request, and the issues may relate to the component elements of the lawsuit that need to be proved.

Additionally and/or alternatively, the review application 136 may supplement the prompt criteria with additional context defining how the generative AI model 134 is to interpret the prompt criteria to classify a composite message file and/or component messages of the composite message file. The review application 136 may convert the prompt criteria, the additional context, and a target composite message file or target component message into a prompt that is input into the generative AI model 134. In some embodiments, at least a portion of the prompt criteria and the additional context may be stored in the workspace data cache 150. For example, the workspace data cache 150 may include language defining the nature of the prompt criteria, specifying what the generative AI model 134 is to output (such as the classification, a description of why the classification was applied, context in the conversation log that led to classification, etc.). Additionally or alternatively, the review application 136 may be configured to generate a prompt based on the prompt criteria (e.g., the descriptions of the one or more issues and/or the one or more relevancy requirements), the additional context, and the target composite message file, that causes the generative AI model 134 to extract fact objects from the composite message file, and/or the associated component messages, and causes the generative AI model to output an indication of the component messages from which the fact objects were extracted.

The outputs of the generative AI model 134 may then be presented via the viewer application 132. Additionally or alternatively, the review application 136 may be configured to update the message metadata for a component message of a composite message file based on the outputs of the generative AI model 134, such as a classification of the component message, a fact object extracted from the component message, and/or an indication that a fact object has been extracted from the component message.

In some embodiments, the prompt criteria may be provided by the user 160 (e.g., via the user device 165) via a graphical user interface presented by the review application 136 and/or the viewer application 132. Examples of the user 160 includes attorneys, prompt engineers, case managers, reviewers, anyone involved in a document review process, etc. Accordingly, examples of the user device 165 includes user devices of: attorneys, prompt engineers, case managers, reviewers, anyone involved in a document review process, etc. In this regard, examples of the user device 165 may include any suitable device(s), such as a computer, a mobile device, a smartphone, a laptop, a phablet, a chatbot or voice bot, etc. The user device 165 may include one or more display devices, one or more processors, one or more memories, etc.

The review application 136 may be configured to evaluate the classification performance of a prompt that is generated based on the prompt criteria, with respect to an input composite message file or set of composite message files (e.g., an initial set of composite message files that includes a sufficient number of examples of each classification type with corresponding instructions included in the prompt). Accordingly, the review application 136 may be configured to generate one or more classification performance metrics with respect to the relevance criteria and/or issues associated therewith across the set of composite message files. For example, the metrics may include recall, precision, elusion, and/or other classification metrics known in the art. It should be appreciated that because a single prompt to the generative AI model 134 may include classification instructions for the relevance criteria and any component issues, modifying the prompt criteria associated with an issue may impact the classification performance with respect to the other classifications defined in the prompt, such as, the relevancy criteria. Accordingly, the review application 136 may be configured to track classification performance (e.g., over time and/or as modifications to the prompt criteria are manually or automatically made) with respect to the relevancy criteria and each issue to detect any potential unintentional performance impacts of modifications to the prompt criteria.

As illustrated, the workspace 110 includes a search application 138 to facilitate review of composite message files. In some embodiments, the search application 138 may generate one or more search indices for the documents ingested into the workspace 110. When indexing composite messages, the search application 138 may be configured to index the component messages of a composite message file in addition to the composite message file as a whole. In some embodiments, the search application 138 may be configured to present a user interface for receiving a search query to search the one or more search indices. In response to the query, the search application 138 may be configured to perform the indicated query to identify one or more responsive documents (including component messages of a composite message file).

The search application 138 may be configured to present the search results via a user interface generated by the viewer application 132. The viewer application 132 may be configured to present a user interface, or a selection interface, by which a user may provide a selection associated with one or more component messages of a composite message file. For example, the selection interface may present a rendering of a composite message file, or a rendering of a segment of a composite message file, that includes one or more component messages. Continuing with this example, the selection interface may include one or more selectable interface elements respectively corresponding to the one or more component messages. Accordingly, the viewer application 132 may be configured to detect, via a selectable interface element, a user selection associated with a component message of the one or more component messages. Additionally or alternatively, the review application 136 may be configured to present, via the viewer application 132, a review interface by which a user may provide review decisions (e.g., relevancy of a component message, responsiveness of a component message, privilege of a component message, etc.) associated with one or more component messages (e.g., component messages selected via the selection interface).

In some embodiments, the viewer application 132, the review application 136, and the search application 138 may be configured to present the graphical user interface (GUIs) described herein on the user device 165. Accordingly, the user device 165 may be configured to interface with the workspace 110 via one or more communication networks. For example, the communication networks may include one or more wired and/or wireless local area networks (LANs), and/or one or more wired and/or wireless wide area networks (WANs), such as the Internet.

As illustrated, the workspace 110 also includes a production application 140 to facilitate generation of production documents, in the eDiscovery context. In some embodiments, the production application 140 may be configured to detect or obtain an indication that a composite message file is to be included in a production of documents (e.g., a request for production). Additionally or alternatively, the production application 140 may be configured to redact one or more component messages, or one or more portions of one or more component messages, based on redaction data associated with the one or more component messages. For example, the message metadata for a component message may include redaction metadata (e.g., a redaction term set, personal identifiable information, intellectual property, health information, government data, financial information, etc.) indicative of a privilege level of the component message. Additionally or alternatively, the production application 140 may be configured to redact, in a composite message file, one or more component messages preceding a redacted component message and/or subsequent to a redacted component message. Additionally or alternatively, the production application 140 may be configured to provide a redacted composite message file including the redacted component messages as an output of the workspace 110 (e.g., as an output to the user device 165).

Furthermore, although the example environment 100 illustrates only one of each of the components, any number of the example components are contemplated (e.g., any number of computing devices, applications, databases, etc.).

### Example Conversation Logs

As mentioned above, the applications executing in the workspace 110 may be configured to facilitate the ingestion of conversation logs 102 into the workspace 110. Examples of the conversation logs 102 include: human to AI interaction logs, email conversation logs, SMS conversation logs, group text conversation logs, etc.

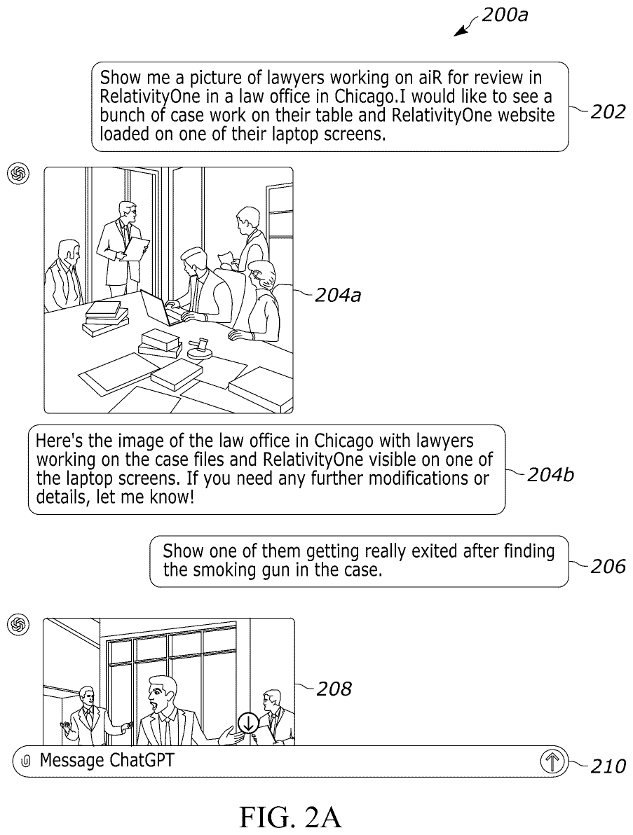

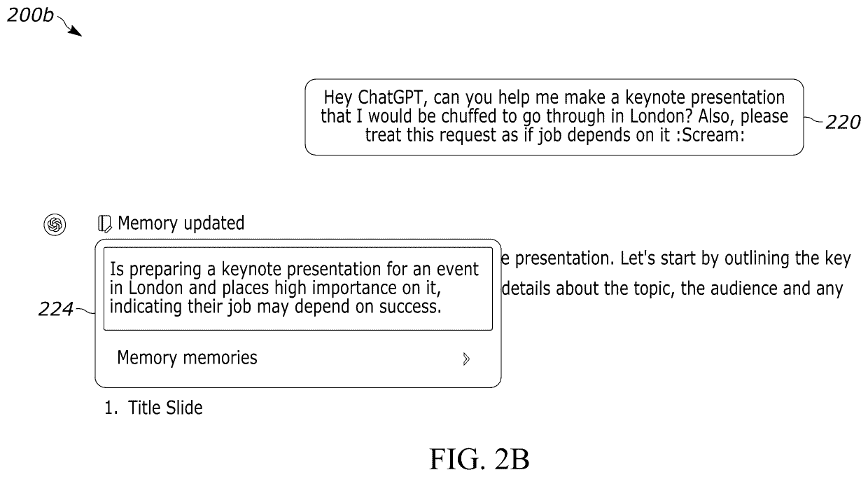

FIG. 2A illustrates an example conversation log 200a from a generative artificial intelligence (AI) platform, such as the platform 104. As illustrated, the conversation log 200a includes component communications 202, 204a, 204b, 206, and 208 each of which are either input by a user or generated by the generative AI platform in response to user input. For example, the component communication 202 includes a prompt instructing the generative AI platform to generate an image. Continuing with this example, the conversation log 200a includes an image and a corresponding image description (e.g., component communication 204a and 204b, respectively), each generated by the generative AI platform in response to the component communication 202.

As mentioned above, the metadata extraction application 130 may segment the conversation logs 102 into component communications (e.g., component communications 202, 204a, 204b, 206, and 208) and generate a composite message file including component messages corresponding to the component communications. Additionally or alternatively, the metadata extraction application 130 may extract message metadata from metadata associated with the component communications, and the metadata extraction application 130 may associate the message metadata with a corresponding component message of the composite message file. For example, the generated image 204a generated by the generative AI platform may be associated with metadata that includes an authenticity indication (e.g., an indication labelling the image as a AI generated file) of the corresponding content file (e.g., the generated image 204a), such as a coalition for content provenance and authenticity (C2PA) tag for the content file, and the metadata extraction application 130 may associate the authenticity indication with the corresponding component message. As another example, the component communications of a conversation log may be associated with metadata including contextual embeddings generated by the generative AI platform during a human to AI interaction.

FIG. 2B illustrates an example contextual embedding generated during a conversation 200b with a generative AI platform. As illustrated, the conversation log 200a includes: a component communication 220 provided by a user, and a contextual embedding 224 automatically generated by the generative AI platform by analyzing user inputs provided to the generative AI platform (e.g., component communication 220). Contextual embeddings generated by a generative AI platform may include a description of a corresponding component communication, or user input, indicative of a message/response context, user intent, user preferences, user sentiment, a conversation topic, etc. For example, a contextual embedding may be indicative of context provided by a user that is associated with an implicit intent of the user. As mentioned above, the contextual embeddings of a composite message file may be included in message metadata associated (e.g., by the metadata extraction application 130) with a corresponding component message or may be included in conversation metadata associated (e.g., by the metadata extraction application 130) with the composite message file.

### Example Composite Message Files

As mentioned above, the applications executing within the workspace 110 may be configured to facilitate ingestion of conversation logs 102 into the workspace 110 for review. Broadly speaking, ingesting a conversation log into the workspace 110 includes converting the conversation log (e.g., the conversation log 200a of FIG. 2A) into a composite message file.

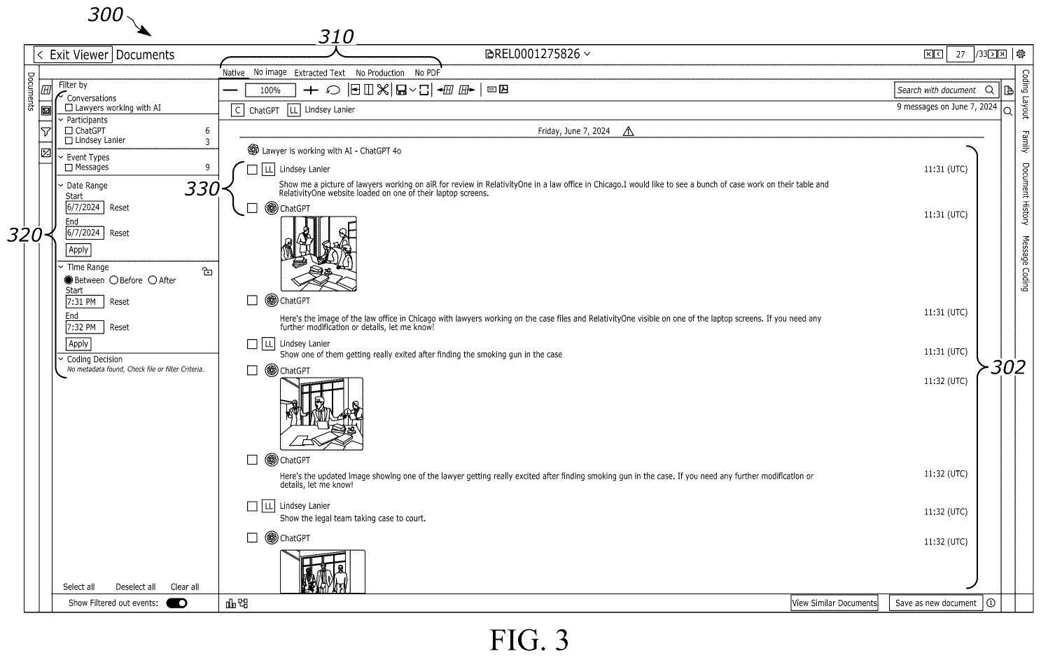

FIG. 3 illustrates an example screen 300 that allows a user to review composite message files. As illustrated, the example screen 300 includes a composite message file 302 corresponding to a conversation log, or a portion of a conversation log. In the illustrated example, the composite message file 302 corresponds to the example conversation log 200a and the component communications 202, 204a, 204b, 206, and 208 of FIG. 2A. As mentioned above, the collections application 124 may segment a conversation log (e.g., conversation log 200a of FIG. 2A) into component communications (e.g., by invoking the metadata extraction application 130) and generate a composite message file (e.g., composite message file 302) such that the component messages of the composite message file correspond to the component communications of the corresponding conversation log. For human to AI interactions, a component communication may be representative of an input prompt from a user or a response generated by the generative AI platform in response to the prompt.

As illustrated, the example screen 300 includes selectable formats 310 corresponding to different formats, display options, and/or layouts for viewing a composite message file. As illustrated, these options include native, no image, extracted text, no production, and no PDF (portable document format). For example, a selectable format 310 may be configured to present the composite message file 302 without generated images from the corresponding conversation log (e.g., conversation log 200a of FIG. 2A). As another example, a selectable format 310 may be configured to present extracted text (e.g., metadata) from the composite message file 302.

As illustrated, the example screen 300 further includes selectable filters 320 corresponding to different filtering categories, such as conversations (e.g., available conversation logs/composite message files in the workspace 110), participants or entities, event types (e.g., messages), date ranges, time ranges, and coding decisions (e.g., review decisions). In some embodiments, the filtering categories may correspond to a field of metadata associated with composite message files. For human to AI interactions, the entities participating in a conversation log may include the generative AI platform.

As illustrated, the example screen 300 includes selectable interface elements 330 corresponding to each component message of the composite message file 302 that may be selected. As described above, the applications executing within the workspace 110 may be further configured to facilitate the classification of documents in the conversation logs 102. In some embodiments, selecting the selectable interface elements 330 causes the viewer application 132 to present a panel for providing coding/review decisions for the selected component messages.

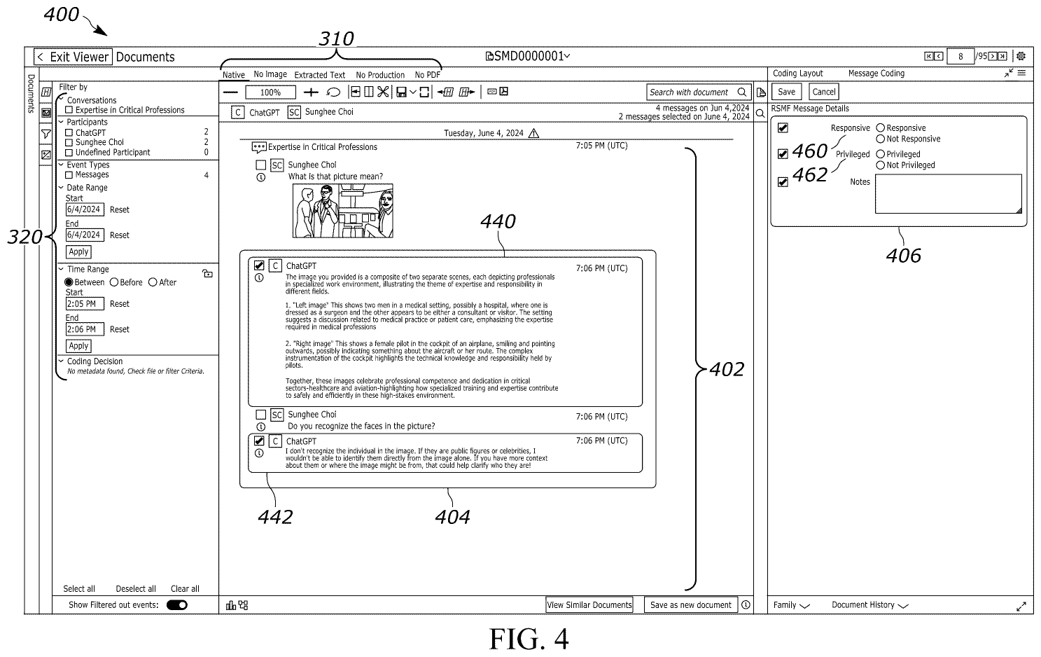

FIG. 4 illustrates an example screen 400 that allows a user to provide coding/review decisions for component messages of a composite message file (e.g., those selected via the selectable interface elements 330). As illustrated, the example screen 400 includes a composite message file 402 corresponding to a conversation log, or a portion of a conversation log. As mentioned above, the application executing within the workspace 110 may be configured to facilitate the review of a composite message file, and more specifically the review of component messages of a composite message file.

As illustrated, the example screen 400 includes selected component messages 404, specifically selected component message 440 and selected component message 442, of the composite message file 402. For example, a user (e.g., user 160) may determine that the selected component messages 404 include information relevant to an inquiry (e.g., an inquiry associated with a discovery request).

As illustrated, the example screen 400 further includes a review interface 406 by which a user may provide coding/review decisions associated with the selected component messages (e.g., selected component messages 404) via the review application 136, for example. The review interface 406 may include a responsive review interface element 460 and/or a privileged review interface element 462. In the illustrated example, the selected component messages 404 may be specified as responsive or not responsive to an inquiry via the responsive review interface element 460. Similarly, the selected component messages 404 may be specified as privileged or not privileged via the privileged review interface element 462. In some embodiments, the review interface 406 includes a notes interface, or comments interface, by which a user may provide notes regarding: the selected component messages 404 and/or the review decisions associated with the selected component messages 404. The review interface 406 may update the message metadata for the selected component messages 404 with coding/review decisions provided via the element 460, 462.

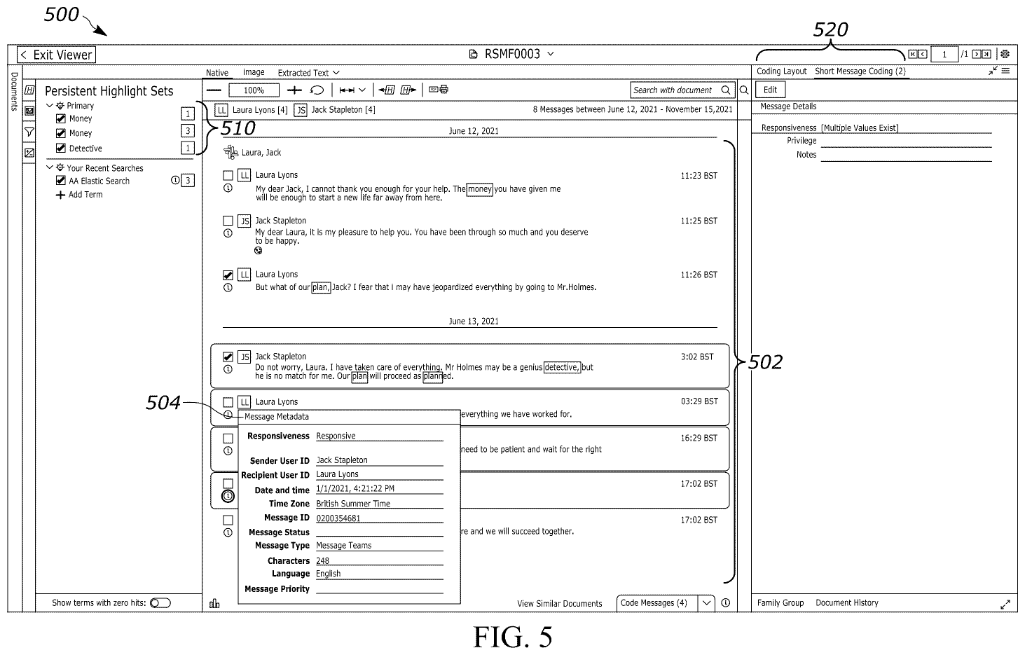

FIG. 5 illustrates an example screen 500 that allows a user to review composite message files, associated composite message file metadata, and component message metadata. As illustrated, the example screen 500 includes a composite message file 502 and component message metadata 504. In the illustrated example, the component message metadata 504 corresponds to different categories including: a responsiveness of a component message, a sender user identification, a recipient user identification, a date and time, a time zone, a component message identification number, a component message status (e.g., read vs. unread, a message priority, or another status indicator supported by the source platform), a message type, a number of characters in the component message, a language of the component message, and a message priority. It should be understood that the component message metadata 504 may include additional categories not depicted in FIG. 5. As mentioned above, the component message metadata (e.g., component message metadata 504) for a component message may be extracted (e.g., via the metadata extraction application 130) from corresponding component communications of the associated conversation log when segmenting the conversation log into component communications.

As illustrated, the example screen 500 includes configurable persistent highlight sets 510 corresponding to different terms of interest that may be specified via the review application 136 (e.g., primary highlight terms and searched terms). As mentioned above, the applications executing within the workspace 110 may be configured to facilitate review of composite message files and associated component messages. In the illustrated example, the configurable persistent highlight sets 510 may facilitate review of the composite message file 502 by highlighting different terms of interest in each component message of the composite message file. In some embodiments, these terms of interest may be specified by a user (e.g., the user 160) via the search application 138. Additionally or alternatively, terms of interest may be associated with a fact object generated by the generative AI model 134 in response to a prompt configured to instruct the generative AI model 134 to extract fact objects from a composite message file.

As illustrated, the example screen 500 further includes a review interface 520 by which a user may provide coding/review decisions associated with the component messages of the composite message file 502. Additionally or alternatively, the review interface 520 may present coding/review decisions associated with a component message that are either: based on a classification of the component message generated by the generative AI model 134, or provided by a user via the review application 136.

### Example Generation of Production Documents

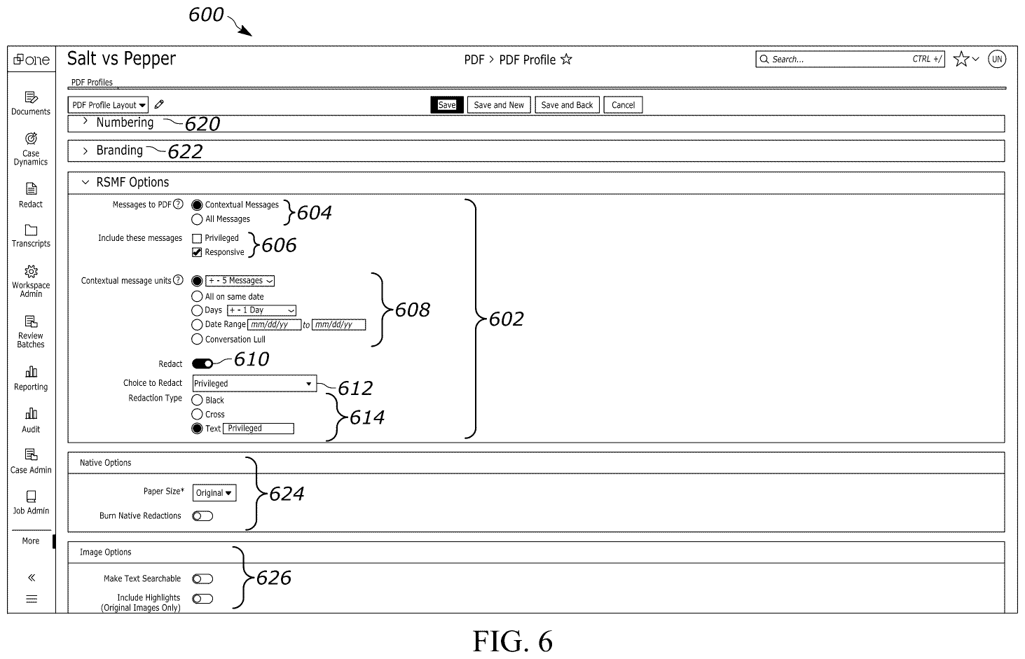

FIG. 6 illustrates an example screen 600 that allows a user to specify formatting for production documents. For example, in the eDiscovery context, a conversation log, or a portion of a conversation log, may be determined to be responsive to a discovery request and/or determined to contain privileged information (e.g., via classifications of the corresponding composite message file output by the generative AI model 134, and/or via review/coding decisions provided by a user via the review application 136). At a high level, the example screen 600 may allow a user to specify a format for a production document via the production application 140. As illustrated, the example screen 600 includes a message formatting interface 602 by which a user may specify formatting selections for a production document including responsive portions of a composite message file via the production application 140.

As illustrated, the message formatting interface 602 may include different selectable formatting interface elements by which a user may specify (e.g., via the production application 140) formatting options for a production document including: messages to PDF 604, messages to be included 606, contextual message units 608, and redaction options 610, 612, and 614. In the illustrated example, the message formatting interface 602 allows a user to specify: whether the production document is to include all component messages of a composite message file, or whether the production document is to include only contextual messages of a composite message file (e.g., messages to PDF 604); whether the production document is to include responsive component messages of a composite message file (e.g., messages to be included 606); whether the production document is to include privileged component messages of a composite message file (e.g., messages to be included 606); an amount of leading and trailing component messages of a responsive/contextual component message to be included in the production document (e.g., contextual message units 608), whether redactions are to be applied to the composite message file for the production document (e.g., redaction option 610), which types of component messages (e.g., privileged component messages) for which redactions are to be applied for the production document (e.g., redaction option 612), and which types of redactions (e.g., black out, cross out, text) are to be applied to the indicated component messages for the production document (e.g., redaction option 614).

As illustrated, the example screen 600 further includes a numbering format interface 620 (e.g., for specifying numbering options for the component messages of a composite message file), a branding format interface 622 (e.g., for specifying branding formatting information), a native formatting interface 624 (e.g., for specifying page size and whether to burn native redactions), and an image formatting interface 626 (e.g., for specifying whether the production documents is to be searchable and whether the production document is to include highlighting sets) by which a user may specify additional formatting options for a production document via the production application 140.

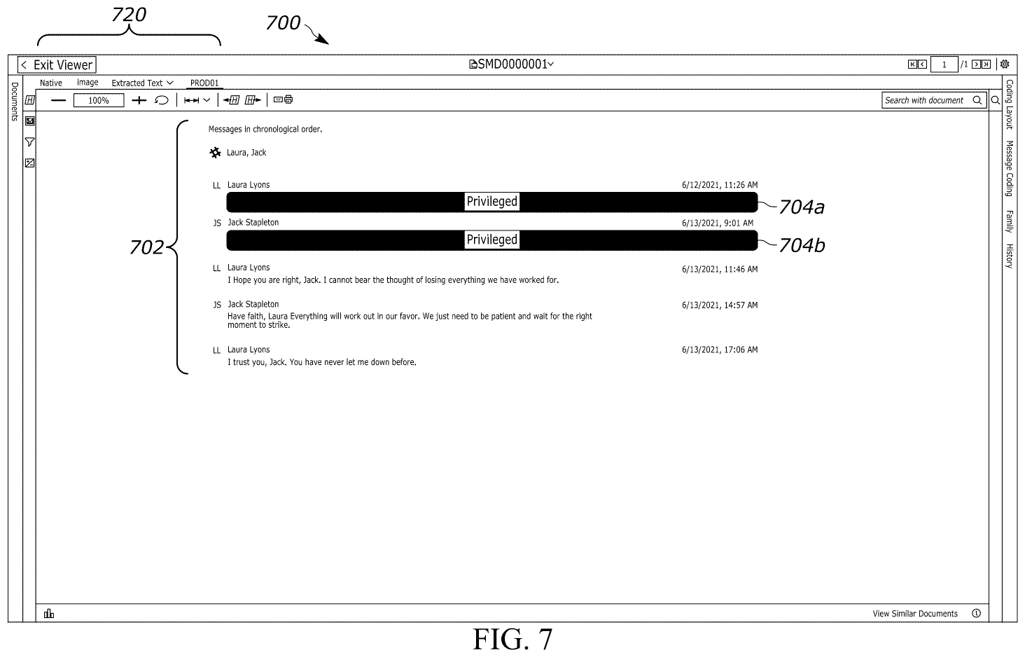

FIG. 7 illustrates an example screen 700 that allows a user to view a conversation log as processed by the production application 140 for production. As illustrated, the example screen 700 includes a production document 702 with two redacted component messages, redacted component message 704a and redacted component message 704b, indicated to be privileged (e.g., via classifications output by the generative AI model 134, and/or via user input via the review application 136).

It should be appreciated that in some embodiments, the component messages 704a, 704b are associated with message metadata that indicate that the component messages are to be redacted. In other embodiments, the production application 140 may be configured (e.g., via the example screen 600) to redact a threshold number of component messages before or after a component message that is associated with message metadata indicative of a need to redact the component message. The example screen 600 may include a user interface element via which the user is able to define the number of component messages before and/or after the redact message to additionally redact.

### Example Methods

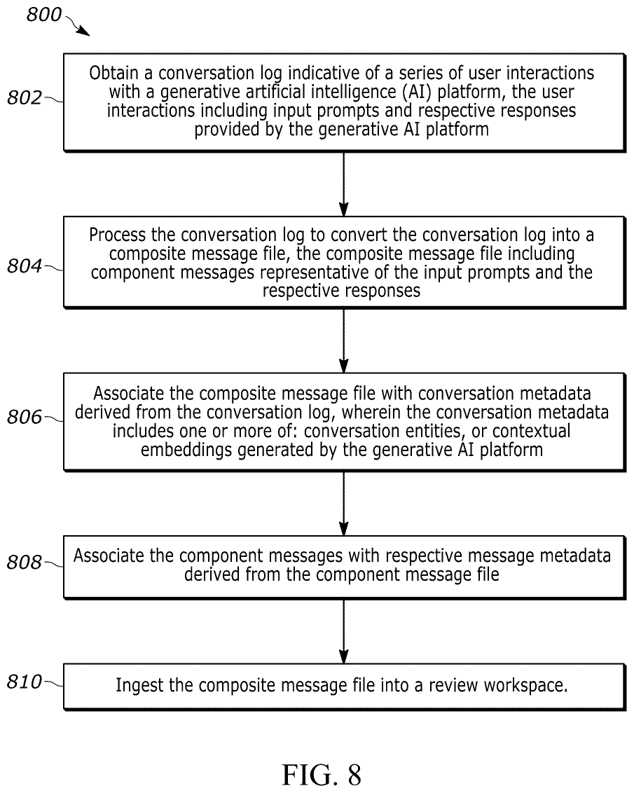

FIG. 8 illustrates a flow diagram representing an example computer-implemented method 800 for ingesting conversation logs into a review workspace. The example method 800 may be implemented by a computing environment 100 hosting the workspace 110. For example, the computing environment 100 may execute one or more of the applications 124, 130, 132, 136, 138, or 140 via the processors 120 and/or the processing unit 920 to perform functions described with respect to the method 800.

The example method 800 may begin at block 802 when the collections application 124 obtains a conversation log (e.g., the conversation log 200a of FIG. 2A) of a series of user interactions with a generative artificial intelligence (AI) platform, the user interactions including input prompts and respective responses provided by the generative AI platform.

At block 804, the review application 136 and/or the metadata extraction application 130 processes the conversation log to convert the conversation log into a composite message file (e.g., the composite message file 302 of FIG. 3), the composite message file including component messages representative of the input prompts and the respective responses. In some embodiments, processing the conversation log further comprises: segmenting the conversation log into component communications; and generating the composite message file such that the component messages correspond to the segmented component communications. In some embodiments, generating the composite message file further comprises: extracting the message metadata from metadata associated with the component communications, via the metadata extraction application 130; and associating the extracted metadata with the corresponding component messages, via the metadata extraction application 130.

At block 806, the metadata extraction application 130 associates the composite message file with conversation metadata derived from the conversation log, wherein the conversation metadata includes conversation entities, and/or contextual embeddings generated by the generative AI platform. The contextual embeddings may be generated by the generative AI platform (e.g., the platform 104 of FIG. 1) during the series of user interactions associated with the conversation logs and may be indicative of at least one of: message and response context, user intent, user preferences, user sentiment, or conversation topics. In some embodiments, the contextual embeddings may be included as component messages of the composite message file. In some embodiments, the conversation entities at least include the generative AI platform as an entity.

At block 808, the metadata extraction application 130 associates the component messages with respective message metadata derived from the component message file. In some embodiments, the message metadata for at least one component message includes redaction metadata indicative of a privilege level of the at least one component message. In such embodiments, the method 800 may further include: detecting, via the production application 140 executing in the workspace 110, an indication that the composite message file is to be included in a production of documents; and redacting, via the production application 140, the at least one component message based on the redaction metadata and the privilege level. In some embodiments, the method 800 further includes providing, via the production application 140, a redacted composite message file including the redacted component messages indicated to be privileged based on the message metadata as an output of the review workspace (e.g., as an output to the user device 165). In some embodiments, redacting the component messages further comprises: redacting, via the production application 140, one or more component messages preceding the at least one component message in the composite message file, and/or redacting, via the production application 140, one or more component messages subsequent to the at least one component message in the composite message file. In some embodiments, the redaction metadata indicates one or more of a redaction term set, personal identifiable information, intellectual property, health information, government data, or financial information, is associated with the at least one component message. In some embodiments, at least one component message of the composite message file includes a content file (e.g., an image) generated by the generative AI platform (e.g., the platform 104 of FIG. 1). In such embodiments, the method 800 may further include associating, via the metadata extraction application 130, component messages including generated content files with respective authenticity indications of the generated content files, wherein the authenticity indications are included in the respective message metadata of the associated component messages.

At block 810, the review application 136 ingests the composite message file into the review workspace (e.g., the workspace 110 of FIG. 1). It should be understood that the method 800 may include one or more additional blocks not depicted in FIG. 8.

In some embodiments, the method 800 may include obtaining, via the review application 136, a description of one or more of an issue and a relevancy requirement associated with the review workspace. In such embodiments, the method 800 may include, based on the description of the one or more of the issue and the relevancy requirement, generating a prompt for input into the generative AI model 134 to classify the component messages of the composite message file as being associated with the issue or the relevancy requirement, via the review application 136. Additionally or alternatively, the method 800 may further include updating, via the metadata extraction application 130, the message metadata for the component messages of the composite message file based on classifications output from the generative AI model 134.

In some embodiments, the method 800 may include generating, via the review application 136, a prompt for input into the generative AI model 134 to extract one or more fact objects from the composite message file, wherein the prompt is configured to cause the generative AI model 134 to output an indication of a component message from which the fact object is extracted. Additionally or alternatively, the method 800 may further include updating, via the metadata extraction application 130, the message metadata for the component messages of the composite message file based on indications output from the generative AI model 134.

In some embodiments, the method 800 may include presenting, via the viewer application 132, a selection interface configured to present a rendering of at least a segment of the composite message file. In some embodiments, the selection interface includes selectable interface elements (e.g., selectable interface elements 330 of FIG. 3) respectively corresponding to each component message of the segment of the composite message file, wherein the selectable interface elements are configured to detect a user selection associated with the one or more component messages. In some embodiments, the review workspace includes a search index associated with the search application 138, and the method 800 further includes indexing, via the search application 138, the component messages of the composite message file into the search index. In such embodiments, the method 800 may include: detecting, via the search application 138, a search query associated with the search index; querying, via the search application 138, the search index using the search query to identify one or more responsive documents, wherein the one or more responsive documents includes one or more responsive component messages of the composite message file; and presenting the one or more responsive component messages via the viewer application 132, wherein the viewer application 132 is configured to present a segment of the composite message file that includes the one or more responsive component message via the selection interface. In some embodiments, the viewer application 132 is configured to present a review interface (e.g., via the review application 136 of FIG. 1) configured to receive one or more review decisions associated with the selected component messages selected via the selection interface. In some embodiments, the method 800 further includes: detecting, via the review interface, a review decision for the selected component messages; and updating, via the metadata extraction application 130, the message metadata for the selected component messages of the composite message file based on the review decision. For example, the review decisions may be indicative of one or more of: relevancy of a component message, responsiveness of a component message, and/or privilege of a component message.

In some embodiments, the review workspace (e.g., the workspace 110 of FIG. 1) includes the review application 136 via which composite message files are reviewed by a reviewer, and the method 800 further includes presenting, via the review application 136, a review interface configured to receive one or more review decisions associated with component messages selected via a selection interface (e.g., a selection interface including the selectable interface elements 330 of FIG. 3) presented by the review application 136.

It should be understood that the method 800 may include implementing one or more additional generative AI models, not including the generative AI model 134, to classify component messages of a composite message file, for example.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘___’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for ingesting conversation logs from generative artificial intelligence (AI) platforms into a review workspace, the method comprising:
obtaining, by one or more processors, a conversation log indicative of a series of user interactions with a generative artificial intelligence (AI) platform, the user interactions including input prompts and respective responses provided by the generative AI platform;
processing, by the one or more processors, the conversation log to convert the conversation log into a composite message file, the composite message file including component messages representative of the input prompts and the respective responses;
associating, by the one or more processors, the composite message file with conversation metadata derived from the conversation log, wherein the conversation metadata includes one or more of: conversation entities, or contextual embeddings generated by the generative AI platform;
associating, by the one or more processors, the component messages with respective message metadata derived from the composite message file; and
ingesting, by the one or more processors, the composite message file into the review workspace.

2. The computer-implemented method of claim 1, wherein:
the contextual embeddings are generated by the generative AI platform during the series of user interactions associated with the conversation log; and
the contextual embeddings are indicative of at least one of: message and response context, user intent, user preferences, user sentiment, or conversation topics.

3. The computer-implemented method of claim 1, wherein the conversation entities at least include the generative AI platform as an entity.

4. The computer-implemented method of claim 1, wherein at least one component message includes a content file generated by the generative AI platform, and the method further comprises:
associating, by the one or more processors, the at least one component message with an authenticity indication of the content file,
wherein the authenticity indication is included in the respective message metadata of the at least one component message.

5. The computer-implemented method of claim 1, wherein processing the conversation log further comprises:
segmenting, by the one or more processors, the conversation log into component communications; and
generating, by the one or more processors, the composite message file such that the component messages correspond to the segmented component communications.

6. The computer-implemented method of claim 5, wherein generating the composite message file further comprises:
extracting, by the one or more processors, the message metadata from metadata associated with the component communications; and
associating, by the one or more processors, the extracted metadata with the corresponding component message.

7. The computer-implemented method of claim 1, further comprising:
obtaining, by the one or more processors, a description of one or more of an issue and a relevancy requirement associated with the review workspace;
based on the description of the one or more of the issue and the relevancy requirement, generating, by the one or more processors, a prompt for input into a generative AI model to classify the component messages of the composite message file as being associated with the issue or the relevancy requirement; and
updating, by the one or more processors, the message metadata for the component messages of the composite message file based on classifications output from the generative AI model.

8. The computer-implemented method of claim 1, further comprising:
generating, by the one or more processors, a prompt for input into a generative AI model to extract one or more fact objects from the composite message file, wherein the prompt is configured to cause the generative AI model to output an indication of a component message from which the fact object is extracted; and
updating, by the one or more processors, the message metadata for the component messages of the composite message file based on indications output from the generative AI model.

9. The computer-implemented method of claim 1, further comprising:
presenting a selection interface configured to present a rendering of at least a segment of the composite message file, wherein:
the selection interface includes selectable interface elements respectively corresponding to each component message of the segment of the composite message file, and
the selectable interface elements are configured to detect a user selection associated with one or more component messages.

10. The computer-implemented method of claim 9, wherein the review workspace includes a search index associated with a search application, and the method further comprises:
indexing, by the one or more processors, the component messages of the composite message file into the search index.

11. The computer-implemented method of claim 10, further comprising:
detecting, by the one or more processors and via the search application, a search query associated with the search index;
querying, by the one or more processors, the search index using the search query to identify one or more responsive documents, wherein the one or more responsive documents includes one or more responsive component messages of the composite message file; and
presenting, by the one or more processors, the one or more responsive component messages via a viewer application, wherein the viewer application is configured to present a segment of the composite message file that includes the one or more responsive component messages via the selection interface.

12. The computer-implemented method of claim 11, wherein:
the viewer application is configured to present a review interface configured to receive one or more review decisions associated with selected component messages selected via the selection interface.

13. The computer-implemented method of claim 12, further comprising:
detecting, via the review interface and by the one or more processors, a review decision for the selected component messages; and
updating, by the one or more processors, the message metadata for the selected component messages of the composite message file based on the review decision.

14. The computer-implemented method of claim 13, wherein the review decision is indicative of one or more of relevancy, responsiveness, or privilege.

15. The computer-implemented method of claim 1, wherein:
the review workspace includes a review application via which composite message files are reviewed by a reviewer, and
the method further comprises:
presenting a review interface configured to receive one or more review decisions associated with component messages selected via a selection interface presented by the review application.

16. The computer-implemented method of claim 1, wherein the message metadata for at least one component message includes redaction metadata indicative of a privilege level, and the method further comprises:
detecting, by the one or more processors and via a production application executing in the review workspace, an indication that the composite message file is to be included in a production of documents; and
redacting, by the one or more processors, the at least one component message based on the redaction metadata and the privilege level.

17. The computer-implemented method of claim 16, further comprising:
providing, by the one or more processors, a redacted composite message file including redacted component messages indicated to be privileged based on the message metadata as an output of the review workspace.

18. The computer-implemented method of claim 16, wherein redacting the component messages further comprises:
redacting, by the one or more processors, one or more component messages preceding the at least one component message in the composite message file or one or more component messages subsequent to the at least one component message in the composite message file.

19. The computer-implemented method of claim 16, wherein the redaction metadata indicates one or more of a redaction term set, personal identifiable information, intellectual property, health information, government data, or financial information, is associated with the at least one component message.

20. A computer system for ingesting conversation logs from generative artificial intelligence (AI) platforms into a review workspace, the computer system comprising:
one or more processors; and
one or more non-transitory memories, the one or more non-transitory memories having stored thereon computer-executable instructions that, when executed by the one or more processors, cause the one or more processors to:
obtain a conversation log indicative of a series of user interactions with a generative AI platform, the user interactions including input prompts and respective responses provided by the generative AI platform;
process the conversation log to convert the conversation log into a composite message file, the composite message file including component messages representative of the input prompts and the respective responses;
associate the composite message file with conversation metadata derived from the conversation log, wherein the conversation metadata includes one or more of: conversation entities, or contextual embeddings generated by the generative AI platform;
associate the component messages with respective message metadata derived from the composite message file; and
ingest the composite message file into the review workspace.

21. A tangible, non-transitory computer readable medium storing computer-readable instructions that, when executed by one or more processors of a computer system, cause the computer system to:
obtain a conversation log indicative of a series of user interactions with a generative AI platform, the user interactions including input prompts and respective responses provided by the generative AI platform;
process the conversation log to convert the conversation log into a composite message file, the composite message file including component messages representative of the input prompts and the respective responses;
associate the composite message file with conversation metadata derived from the conversation log, wherein the conversation metadata includes one or more of: conversation entities, or contextual embeddings generated by the generative AI platform;
associate the component messages with respective message metadata derived from the composite message file; and
ingest the composite message file into a review workspace.
